(19) United States
(12) Patent Application Publication
(10) Pub. No.: US 2016/0224460 A1
(43) Pub. Date: Aug. 4, 2016

(54) SOFTWARE-DEFINED NETWORK APPLICATION DEPLOYMENT

(71) Applicant: HEWLETT PACKARD ENTERPRISE DEVELOPMENT LP, Houston, TX (US)

(72) Inventors: Andy BRYANT, Grenoble (FR); Debasish BISWAS, Palo Alto, CA (US); Paul VINCIGUERRA, Roseville, CA (US)

(73) Assignee: HEWLETT PACKARD ENTERPRISE DEVELOPMENT LP, Houston, TX (US)

(21) Appl. No.: 15/025,886

(22) PCT Filed: Apr. 29, 2014
(86) PCT No.: PCT/US14/35901

§ 371 Date: Mar. 29, 2016

Related U.S. Application Data
(60) Provisional application No. 61/884,905, filed on Sep. 30, 2013.

(51) Int. Cl. G06F 11/36; G06F 9/445

(52) U.S. Cl. CPC G06F 11/3664; G06F 11/3692; G06F 8/60

(57) ABSTRACT

Software-defined network application deployment can include receiving a developed SDN application and deploying the SDN application into a remote testing lab for testing.

### CROSS-REFERENCE TO RELATED APPLICATIONS

This application claims priority to U.S. Provisional Application 61/884,905, filed Sep. 30, 2013, which is incorporated by reference.

### BACKGROUND

A software-defined network (SDN) is a form of network virtualization in which the control plane (system that makes decisions that affect network traffic) is separated from the data plane (system that moves the network traffic) and implemented as software. The control plane refers to definition of how network traffic is handled (e.g., via protocols such as spanning tree, open shortest path first, border gateway protocol, etc.) in a network device. The data plane refers to the actual handling of the network traffic according to the control plane (e.g., using forwarding tables, routing tables, queues, etc.) in a network device. The control plane may be said to be distributed in a typical network where each network device includes a control plane and a data plane. As a result, in the event of network congestion, each network device may take corrective action largely independently of other network devices. However, in an SDN, network administrators can have programmable (e.g., centralized) control of network traffic without requiring physical access to the network's hardware devices.

### BRIEF DESCRIPTION OF THE DRAWINGS

FIG. 1 is a diagram illustrating an example of a system according to the present disclosure.

FIG. 2 is a diagram illustrating an example of a device according to the present disclosure.

FIG. 3 is a diagram illustrating an example of a software-defined network (SDN) ecosystem according to the present disclosure.

FIG. 4 is a flow chart illustrating a method according to the present disclosure.

### DETAILED DESCRIPTION

Software-defined networking is an emerging network architecture where network control is decoupled from forwarding and is directly programmable. This migration of control, formerly tightly bound in individual network devices, into accessible computing devices enables the underlying infrastructure to be abstracted for applications and network services, which can treat the network as a logical or virtual entity.

Some SDN implementations may lack a process or include a slow process for testing newly created SDN applications. As used herein, an SDN application refers to program instructions that can be installed on an SDN controller (e.g., a network controller) to provide and/or modify functionality to a new and/or existing SDN. For instance, some examples of testing SDN applications may involve a multi-step process for testing SDN application.

In contrast, SDN application deployment according to the present disclosure can include a streamlined workflow, such that an application developer can develop and test an SDN application in one streamline workflow (e.g., remote lab to development workflow). For instance, the developer may develop the SDN application and deploy it to a remote test lab in accordance with the present disclosure. As a result, the developer can upload his SDN application, test the application in a version of its intended environment, and collect a report of the results in one motion (e.g., with access via a graphical user interface (GUI)).

Integration of remote lab to development workflow (e.g., also known as tool chain) can allow for an application that once compiled and locally tested can be deployed (e.g., uploaded) directly from a developer workspace to the remote lab where the developer can run it in a real network of devices that the application may be expected to encounter in a real deployment. Once the application is run in the remote lab, results and network configuration can be downloaded into the developer workbench for follow on workflow (e.g., submitting to an SDN application store), as will be discussed further herein.

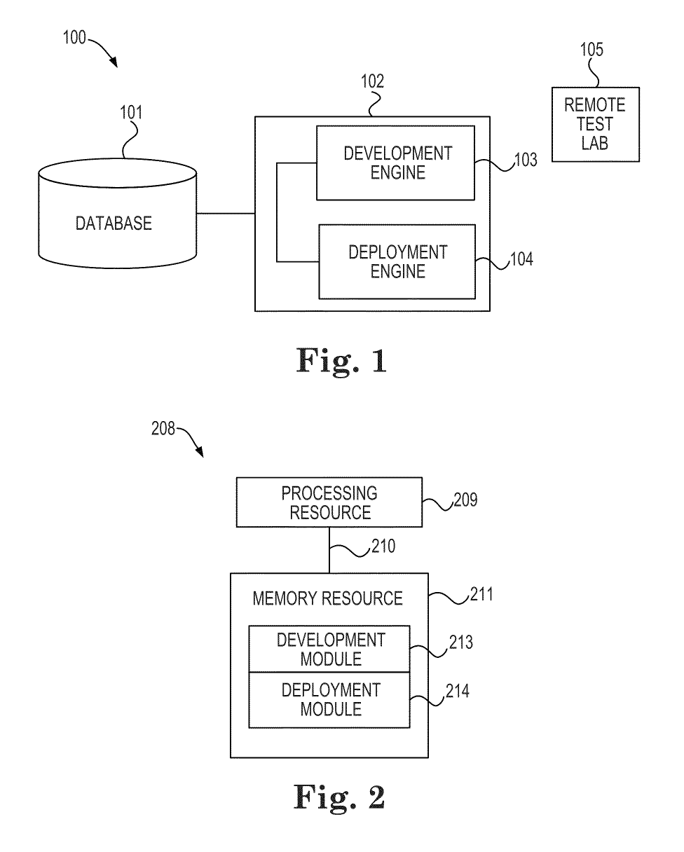

FIGS. 1 and 2 illustrate examples of systems 100 and device 208 according to the present disclosure. FIG. 1 is a diagram illustrating an example of a system 100 according to the present disclosure. The system 100 can include a database 101, a subsystem 102, and/or a number of engines 103, 104. As used herein, “a” or “a number of” something can refer to one or more such things. For example, “a number of widgets” can refer to one or more widgets. The subsystem can include the number of engines in communication with the database 101 via a communication link. The system 100 can include additional or fewer engines than illustrated to perform the various functions described herein. The system 100 and/or the subsystem 102 can represent software and/or hardware of an SDN controller (e.g., device 208 as referenced in FIG. 2, etc.).

The number of engines 103, 104 can include a combination of hardware and programming that is configured to perform a number of functions described herein (e.g., deployment of an SDN application into a remote test lab). The programming can include program instructions (e.g., software, firmware, etc.) stored in a memory resource (e.g., computer readable medium (CRM), machine readable medium (MRM), etc.) as well as hard-wired program (e.g., logic).

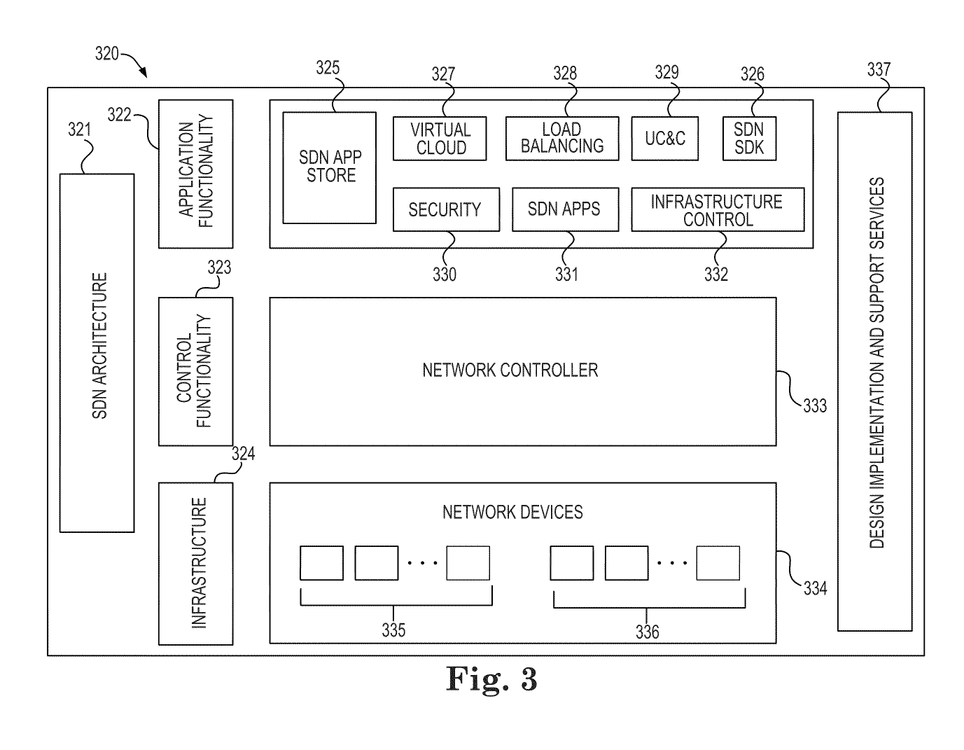

The development engine 103 can include hardware and/or a combination of hardware and programming to receive a developed SDN application. For instance, a developer may upload (e.g., via a GUI) an SDN application he or she hopes to upload to an application store. The SDN application, in some instances, can include a new SDN application. As used herein, a new or newly created SDN application can include an SDN application not previously stored in an SDN application store within an SDN ecosystem, as will be discussed further herein with respect to FIG. 3. The SDN application can include an SDN application developed using an SDN software development kit (SDK), as will be discussed further herein.

The deployment engine 104 can include hardware and/or a combination of hardware and programming to deploy the developed SDN application into the remote test lab 105 for testing. In some examples, the deployment engine can upload the SDN application to the remote test lab using a file transfer protocol (FTP).

Remote test lab 105 can include an environment to test SDN applications (or other types of applications) located remotely from an SDN ecosystem. However, in some examples, the remote test lab 105 may be located within the SDN ecosystem. Remote test lab 105 can be, in some instances, a virtual test lab. A virtual test lab can include an environment hosted on a cloud system that can be accessed by a user to test an SDN application, as will be discussed further herein with respect to FIG. 3. The remote lab can use real devices, but in some examples, it may be considered a virtual lab because the lab infrastructure is shared between multiple developers simultaneously while providing isolation between their respective test environments.

In some examples, the system 100 can include a capture engine (not illustrated in FIG. 1) to capture a test result of the testing performed on the application in the remote test lab. A developer may receive these captured test results (e.g., positive or negative performance in the environment) and use them when attempting to get his or her SDN application into the application store. In some instances, the capture engine can compress and package the test result (e.g., to send with a submission of the SDN application for entry into the application store). Packaging can include, for instance, compiling any information that may be needed for entry into the application store (e.g., test results, packet information, etc.)

Each of the number of engines 103, 104 can include hardware and/or a combination of hardware and programming that can function as a corresponding module as described with respect to FIG. 2. For example, the development engine 103 can include hardware and/or a combination of hardware and programming that can function as the development module 213. In another example, the deployment engine 104 can include hardware and/or a combination of hardware and programming that can function as the deployment module 214.

FIG. 2 is a diagram illustrating an example of a device 208 (e.g., an SDN controller) according to the present disclosure. The device 208 can utilize software, hardware, firmware, and/or logic to perform a number of functions.

The device 208 can be a combination of hardware and program instructions configured to perform a number of functions (e.g., actions). The hardware, for example, can include a number of processing resources 209 and a number of memory resources 211 (e.g., CRM, MRM, database, etc.). The memory resources 211 can be internal and/or external to the device 208 (e.g., the device 208 can include internal memory resources and have access to external memory resources). The program instructions (e.g., machine-readable instructions (MRI)) can include instructions stored on the MRM to implement a particular function (e.g., an action such as provide access to a plurality of SDN applications to the plurality of users). The MRI can be executable by one or more of the processing resources 209. The memory resources 211 can be coupled to the device 208 in a wired and/or wireless manner. For example, the memory resources 211 can be an internal memory, a portable memory, a portable disk, and/or a memory associated with another resource, e.g., enabling MRI to be transferred and/or executed across a network such as the Internet.

Memory resources 211 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resources 209 can be coupled to the memory resources 211 via a communication path 210. The communication path 210 can be local or remote to the device 208. Examples of a local communication path 210 can include an electronic bus internal to a machine, where the memory resources 211 are in communication with the processing resources 209 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 210 can be such that the memory resources 211 are remote from the processing resources 209, such as in a network connection between the memory resources 211 and the processing resources 209. That is, the communication path 210 can be a network connection. Examples of such a network connection can include LAN, wide area network (WAN), PAN, and the Internet, among others.

As shown in FIG. 2, the MRI stored in the memory resources 211 can be segmented into a number of modules 213, 214 that when executed by the processing resources 209 can perform a number of functions. As used herein, a module includes a set of instructions included to perform a particular task or action.

Development module 213, for instance, can include instructions to receive a new software defined network (SDN) application for deployment in an SDN ecosystem, wherein the new SDN application includes an SDN application not previously stored in an SDN application store within the SDN ecosystem. Deployment module can include instructions to deploy the SDN application into a remote test lab for testing. In some examples, modules 213, 214, and/or other modules (not illustrated in FIG. 2) can compile and package the SDN application in response to the testing and capture and create a report of results of the testing.

The number of modules 213, 214 can be sub-modules of other modules. For example, the development module 213 can be a sub-module of the deployment module 214 and/or the development module 213 and the deployment module 214 can be contained within a single module. Furthermore, the number of modules 213, 214 can comprise individual modules separate and distinct from one another. Examples are not limited to the specific modules 213, 214 illustrated in FIG. 2.

FIG. 3 is a diagram illustrating an example of a SDN ecosystem 320 according to the present disclosure. The SDN ecosystem can comprise a single architecture deployed across a data center network, a campus area network, and a plurality of branch networks. The SDN ecosystem 320 can include an SDN architecture 321. The SDN architecture 321 can include application functionality 322, control functionality 323, and/or infrastructure 324. Further, the application functionality 322 can include an SDN application store (e.g., SDN App Store) 325 and/or an SDN SDK 326. The application functionality can include virtual cloud 327, load balancing 328, unified communications and collaboration (UC&C) 329, security 330, SDN applications 331, and/or infrastructure control 332. As illustrated in FIG. 3, the control functionality 323 can be provided by an SDN controller 333 (e.g., a virtual application networks (VAN) SDN controller). However, in some instances, an SDN application can be hosted by machines separate from the SDN controller. Also, as illustrated in FIG. 3, the infrastructure 324 can include a number of network devices 334 such as a number of switches 335 and/or a number of routers 336. In some examples, the SDN ecosystem 320 can provide design implementation and support services 337.

An SDN is a form of network virtualization in which the control plane is separated from the data plane and implemented in a software application. Network administrators can therefore have programmable centralized control of network traffic without requiring physical access to the network's hardware devices. As noted, the SDN ecosystem 320 can include an SDN controller 333 (e.g., a SDN controller). The SDN controller 333 can be hardware and/or software. A hardware SDN controller 333 can include a processing resource in communication with a memory resource. The memory resource can include instructions, executable by the processing resource to perform a number of functions described herein. In some examples, the SDN controller 333 can be a discrete device, such as a server. In some examples, the SDN controller 333 can be a distributed SDN controller, for example, such as a cloud-provided functionality. Also, the SDN controller 333 can be in communication with and/or have control over a number of network devices.

In some examples, a software SDN controller 333 can be a VAN SDN controller. The VAN SDN controller 333 can be offered as licensable software to provide centralized automation for an SDN and/or open application programming interfaces (APIs) to enable third-party SDN application development. The VAN SDN controller 333 can have an extensible, scalable, and/or resilient controller architecture that can provide simplified management, provisioning, and/or orchestration in the SDN architecture 321. The VAN SDN controller 333 can help provide a federated network solution designed to provide unified automation of, and visibility into, physical and virtual data center networks, enabling business agility and improving business continuity.

An SDN ecosystem 320 can include a programmable network aligned to business applications. That is, the SDN ecosystem 320 can conform to a number of open standards to facilitate efficient use for different customers, partners, businesses, etc. In some examples, the SDN ecosystem 320 can be deployed across a data center network, a campus area network, and/or a branch network. Any combination of the data center network (or multiple data center networks), the campus area network (or multiple campus area networks), and the branch network (or multiple branch networks) can be included in the SDN ecosystem 320.

An SDN application (e.g., SDN App) 331 can be program instructions (e.g., a Java program) that can be executed on the SDN controller 333 (e.g., as an Open Services Gateway initiative (OSGi) bundle using a Java SDK) or off the SDN controller 333 using an API implemented by the SDN controller 333 (e.g., a northbound interface that conceptualizes the lower level details such as data or functions). As used herein, OSGi refers to a specification for Java based frameworks for development and dynamic deployment of modular components and libraries of a system. Some OSGi implementations can include Equinox, Apache Felix, and/or Knopflerfish OSGi. On OSGi bundle can be a tightly coupled, dynamically loadable collection of classes, jars, and/or configuration files onto a Java framework implementation of the OSGi specification.

In some examples, SDN applications 331 can interact with the network devices 334 and/or virtual machines to incorporate new and/or additional functionalities into the SDN ecosystem 320. For instance, the SDN ecosystem 320 can include an SDN application store 325 that provides access to SDN applications 331 that can be installed on an SDN controller 333 to provide and/or modify functionality to a new and/or existing SDN. Further, the SDN application store 325 can be used to collect and maintain SDN applications 331 (e.g., in categories such as SDN, security 330, data center, virtual cloud 327, load balancing 328, UC&C 329, and infrastructure control 332, among others).

A user (e.g., human or machine) of the SDN application store 325 can log in to an SDN controller 333 and install SDN applications 331 from the SDN application store 325 on the SDN controller 333. In some examples, the SDN application store 325 can be provided by a first entity that is distinct from an entity that owns and/or manages a particular SDN. For example, a supplier of SDN hardware (e.g., SDN network devices such as SDN controllers, switches, routers, etc.) and/or software can provide the SDN application store 325 for access by customers of the supplier. As such, the supplier, customers, and/or third parties can have access to the SDN application store 325. Access to the SDN application store 325 can include access to develop, use, simulate, certify, validate, purchase, and/or sell SDN applications 331, among other types of access. In some examples, users can collaborate to provide improvements to SDN applications 331. For example, users may provide recommendations and/or comments on how to improve various SDN applications 331. Additionally, users can browse and/or search for SDN applications 331 in the SDN application store 325.

SDN applications 331 in the SDN application store 325 can be shared with all users or with subsets of users. For example, a particular user can have a private portal to the SDN application store 325 that allows the particular user to have access to SDN applications 331 that are shared with the particular user, but not with all users. Similarly, the SDN application store 325 can promote wider exposure and/or increased sales for user developed SDN applications 331 by allowing a larger audience to access the SDN applications 331. In some examples, a provider of the SDN application store 325 (e.g., a provider of the front and back end infrastructure) may collect a portion of the sales recognized from the SDN application store 325.

In some examples, access to the SDN application store 325 can be provided via a graphical user interface (GUI). The GUI can include a display of SDN applications 331 organized by category. For example, the SDN applications 331 can be displayed in the SDN application store 325 and on a GUI, and can be organized into categories such as cloud, data center, featured, management, monitoring and troubleshooting, orchestration, and/or security, among other categories. From the GUI, a user can select a number of SDN applications 331 and install them on the user's SDN controller 333 via the GUI. Also, users can provide ratings for the SDN applications 331 in the SDN application store 325 via the GUI. A rating can include a numerical, alphanumerical, and/or symbolic value representing the user's satisfaction with a particular SDN application. In some examples, the GUI can provide descriptions of the SDN applications 331 to help users determine whether a particular SDN application is appropriate for the user's SDN.

In some examples, the SDN application store 325 can be accessed through a user interface (UI) of the SDN controller 333 (e.g., via the SDN controller's 333 native UI, which may then access the SDN application store through a programmatic RESTful API (e.g., a web API implemented using hypertext transfer protocol (HTTP) and REST principles as a collection of resources).

In a number of examples, a user browsing the application store can see the test results within a particular test environment before selecting which applications to download. Additionally, SDN controller 333 can compare the user's environment (e.g., SDN controller and connected network) to a test environment for which the application was tested to determine how close (e.g., using a percent match figure) his or her environment is as compared to that under which an application was tested. For instance, a user's SDN controller environment can be compared to an environment of the remote test lab and an application effectiveness level (e.g., percent match figure) for the user's SDN controller environment can be provided to the user.

The SDN ecosystem 320 can include an overlay network and an underlay network. As used herein, an overlay network refers to a network that is built on an underlay network. Also, as used herein, an underlay network refers to a number of SDN enabled network devices such as switches and/or routers. Network devices in the underlay network can employ an open protocol.

One example of an open protocol for an SDN is OpenFlow. As used herein, OpenFlow refers to a communication protocol that provides access to a forwarding plane of a network device over a network. Some examples of the present disclosure can operate according to OpenFlow. However, examples are not so limited, and examples of the present disclosure can operate according to other SDN protocols, and/or a hybrid of an SDN protocol combined with “normal” (e.g., distributed control plane) networking protocols. In some examples, network devices (e.g., routers) in the underlay network can be enabled with network functions virtualization (NFV) to provide some network functions with generic servers rather than dedicated network devices. For example, a virtual services router (VSR) can be deployed in a data center, branch, and/or cloud environment and can offer branch services that are centralized (e.g., in the data center), with branch instances logically managed as if they were remote but rather hosted in the data center. A VSR can be a single-tenant virtualized software wide area network (WAN) router designed for multi-tenant, hosted public clouds and virtualized branch customer-premises equipment (CPE) deployments. A VSR can be a virtualized software router that can run on VMware and/or a hypervisor (e.g., a software program that manages multiple operating systems or multiple instances of the same operating system, on a single computer system). In some examples, network devices in the underlay network can be configured to support an overlay network (e.g., overlay enabled).

The overlay network can employ an encapsulation protocol such as virtual extensible local area network (VXLAN) to run the overlay network on the underlay network (e.g., on a Layer 2 and/or Layer 3 infrastructure). VXLAN can facilitate a cloud computing environment while logically isolating applications and/or tenants that use a portion of the cloud computing environment. For example, each tenant can have its own logical network and network identification in the cloud computing environment with an extended virtual local area network (VLAN) addressing space provided by VXLAN. The overlay network can employ network virtualization using generic routing encapsulation (NVGRE) to tunnel Layer 2 packets over a Layer 3 network to alleviate scalability problems associated with the cloud computing environment. In some examples, the overlay network can provide a number of virtual machines.

As illustrated in FIG. 3, the SDN ecosystem 320 can include an SDN SDK 326 (e.g., an open SDN SDK) to facilitate development, simulation, certification and/or validation of SDN applications 331. The SDN SDK 326 can be provided by executable instructions that can be downloaded and installed by a user and/or run remotely for use by the user. For example, the SDN SDK 326 can be provided as a virtual desktop infrastructure (VDI). A VDI can be a service that hosts user desktop environments on a remote server that can be accessed over a network using a remote display protocol. A connection brokering service can connect the user to a desktop session of the user so that the user can access the desktop of the user from any location without being constrained to a single device.

The SDN SDK 326 can include a development suite that includes APIs and documentation, a GUI framework, a VAN SDN controller 333, and a developer guide and/or sample code to help developers of SDN applications 331 with a development framework to quickly create SDN applications 331 directly on the VAN SDN controller 333. The SDN SDK 326 can include an API design model such as a representational state transfer (REST) API. REST can be an architectural style that abstracts architectural elements within a distributed hypermedia system that ignores the details of component implementation and protocol syntax in order to focus on the roles of components, the constraints upon interaction with other components, and interpretation of significant data elements. The SDN SDK 326 can include a RESTful API.

The SDN SDK 326 can include a simulation suite that allows users to download software directly into a development environment and simulate networks with network simulation modules (e.g., using modules that create a realistic virtual network, running real kernel, network device and application code, on a real or virtual machine to simulate how the SDN will respond to a particular SDN application before it is actually implemented live in the SDN). An example of a network simulation tool is Mininet. The SDN SDK 326 can include a certification and/or validation suite that can provide and/or perform a certification and/or validation test for SDN applications 331 to determine whether a particular application meets defined standards (e.g., set by a provider of the SDN ecosystem 320) so that SDN applications 331 can be given an indication of certification and/or validation for the comfort of users. Testing, certification and/or validation can provide investment protection to help ensure that a user's network infrastructure can support SDN applications 331 as they become available. In some examples, the SDN SDK 326 can include a community portal (e.g., a forum for users to share ideas) and/or a knowledge base to enable collaboration, including creation of private working groups, training, services, and support.

In some examples, the certification and/or validation suite can include an SDN remote test lab for testing SDN application functionality and interoperability across proprietary and/or open applications in a ready-made environment that simulates user conditions without requiring the user to have access to real network devices. The SDN remote test lab can be hosted in a cloud environment and can be accessible by a user (e.g., an application developer) to test an SDN application 331 with a set of shared network devices, such as switches, routers, and/or computing devices (e.g., a server) among other network devices. The remote test lab test can run on a set of real network devices and servers that are configured to be used in an isolated and protected configuration for the purpose of testing an SDN application 331. In some examples, once a particular remote test lab is reserved by a user, it can be exclusively used by the user for the duration of testing. The remote test lab can present a GUI to the user to allow the user to create a network to test the SDN application 331.

The SDN ecosystem 320 can include a number of modules to help users (e.g., information technology professionals, SDN application developers, etc.) to understand good practices for adopting and implementing an SDN. For example, the SDN ecosystem 320 can include a preparation module to help a user understand the user's network and how the SDN can be implemented. By way of example, the Open Flow protocol can be explained to the user and/or an introduction to the SDN SDK 326 can be provided. The SDN ecosystem 320 can include an engagement module that allows users to take SDN deployment courses and/or SDN development courses, among others. A user can have a service agreement with a provider of the SDN ecosystem 320 allowing the user to have access (e.g., via telephone, email, web interface, etc.) to explanations and clarifications of APIs, software documentation, sample SDN applications 331, troubleshooting resources for SDN applications 331 and/or SDN controller 333, development of workarounds, sharing best practices, knowledge, development expertise, and/or self-validation testing assistance, among others. Also, the SDN ecosystem 320 can include a delivery module that allows users and/or SDN applications 331 to earn certification and/or validation. In some examples, the delivery module can be used to deploy SDN applications 331 (e.g., to the SDN application store 325).

In a number of examples of the present disclosure, SDN ecosystem 320 can provide a user (e.g., a developer) with an ability to develop and test an SDN application 331 in one streamlined workflow (e.g., so that the developer can validate the functionality of the SDN application 331). For example, the user can use the SDN ecosystem 320 by downloading the SDN controller 333 (e.g., a VAN SDN controller) and/or the SDN SDK 326 and installing them on the same server. The user can use the SDN controller 333 and the SDN SDK 326 to develop an SDN application 331 that implements functionality that the user believes brings value to customer networks. Once the SDN application 331 is compiled and packaged, the user can test it using the SDN controller 333 (e.g., a feature on the SDN controller 333) to deploy the SDN application 331 onto the remote test lab (e.g., by uploading the SDN application 331 to the remote test lab using an FTP).

Once on the remote test lab, the user can create a network configuration that is similar to a customer network that can exercise the functions of the SDN application 331. If the user finds issues with the SDN application 331, the user can address (e.g., fix) them on the original setup. For example, the user can create and/or capture logs and reports from the test network. Once satisfied with the functions of the SDN application 331, the user can submit the SDN application test results and report for approval (e.g., to a provider of the SDN ecosystem 320 and/or the SDN application store 325). In some instances, the results can be validated by a user and/or a program (e.g., for approval). The test network can include modules to capture test results (e.g., packets sent, packets received, errors in transmission, and/or log messages, etc.). In some examples, the test results can be archived (e.g., in a folder) and/or compressed and packaged for submission and/or transfer after testing. Once approved, the SDN application 331 can submitted for uploading (e.g., by the provider) to the SDN application store 325. If the SDN application is not approved, submission of the SDN application 311 for uploading can be prevented while the user addresses the issue.

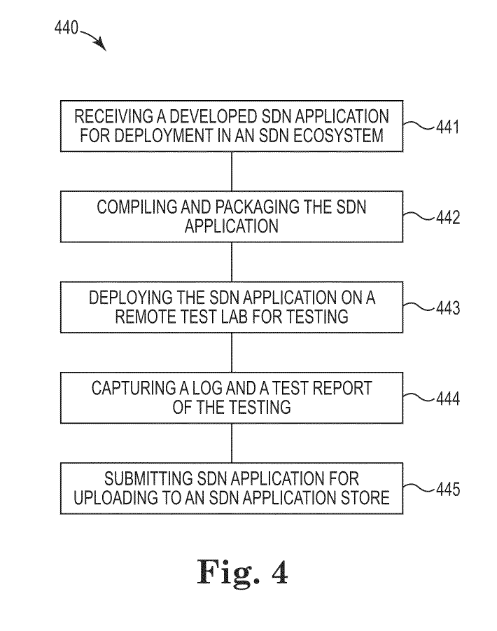

FIG. 4 is a flow chart illustrating a method 440 according to the present disclosure. At 441, the method 440 can include receiving a developed SDN application for deployment in an SDN ecosystem. For instance, this can include receiving a developed SDN application for deployment in an SDN ecosystem using a controller and an SDK installed on a same server.

At 442, method 440 can include compiling and packaging the SDN application, for instance, using the controller. For instance, the application may be compiled in preparation for deployment onto the remote test lab.

At 443, method 440 can include deploying the SDN application on a remote test lab for testing. This can include, for instance, deploying the SDN application using the controller and via an FTP. In a number of examples, deploying the SDN application can include deploying the SDN application on the SDN controller within the remote test lab (e.g., a cloud-hosted virtual test lab).

At 444, method 440 can include capturing a log and a test report of the testing. This log and test report can indicate to the developer the success of his or her SDN application in the virtual test lab. In some instances, this captured log and captured test report can be used when submitting the SDN application for possible inclusion in the application store.

At 445, method 440 can include submitting the SDN application for uploading to an SDN application store, for instance, in response to the log and the test report. In some instances, this can include submitting the SDN application along with the captured log and captured test report as a package for uploading to the SDN application store.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A system, comprising:
a remote test lab; and
a controller within a software-defined network (SDN) ecosystem, comprising:
a development engine to receive a developed SDN application; and
a deployment engine to deploy the developed SDN application into the remote test lab for testing.

2. The system of claim 1, including a capture engine to capture a test result of the testing.

3. The system of claim 3, the capture engine to compress and package the test result.

4. The system of claim 1, wherein the remote test lab includes a virtual test lab hosted on a cloud system.

5. The system of claim 1, wherein the controller is installed on a same server as an SDN software development kit (SDK) within the SDN ecosystem.

6. The system of claim 1, including the development engine to receive the developed SDN application, such that the developed SDN application is developed using an SDN SDK.

7. The system of claim 1, wherein the SDN ecosystem includes a single architecture deployed across a network.

8. A non-transitory machine readable medium storing instructions executable by a processing resource to cause a computer to:
receive a new software defined network (SDN) application for deployment in an SDN ecosystem, wherein the new SDN application includes an SDN application not previously stored in an SDN application store within the SDN ecosystem;
deploy the SDN application into a remote test lab for testing;
compile and package the SDN application in response to the testing; and
capture and create a report of results of the testing.

9. The non-transitory machine readable medium of claim 8, wherein the report of results includes at least one of a report of log messages, packets sent, packets received, and errors in transmission.

10. The non-transitory machine readable medium of claim 8, including instructions executable to submit the SDN application for uploading to an SDN application store in response to an approval of the report result.

11. The non-transitory machine readable medium of claim 8, including instructions executable to prevent submission of the SDN application for uploading to an SDN application store in response to a disapproval of the report result.

12. A method, comprising:
receiving a developed software-defined network (SDN) application for deployment in an SDN ecosystem using an SDN controller and a software development kit (SDK) installed on a same server;
compiling and packaging the SDN application using the SDN controller;
deploying, using the SDN controller, the SDN application into a remote test lab for testing;
capturing a log and a test report of the testing; and
submitting the SDN application for uploading to an SDN application store in response to the log and the test report.

13. The method of claim 12, wherein deploying the SDN application includes deploying the SDN application on the SDN controller within the remote test lab.

14. The method of claim 14, wherein submitting the SDN application for uploading includes submitting the SDN application along with the captured log and test report as a package for uploading to the SDN application store.

15. The method of claim 12, including:
comparing a user's SDN controller environment to an environment of the remote test lab; and
providing to the user an application effectiveness level for the user's SDN controller environment.
